(19) United States
(12) Patent Application Publication
(10) Pub. No.: US 2005/0257579 A1
(43) Pub. Date: Nov. 24, 2005

(54) Force isolating applicance

(75) Inventors: Daniel C. Conrad, Stevensville, MI (US); Robert J. Michael, Erie, PA (US); Mark M. Xie, St. Joseph, MI (US); Ernest B. Ferro, Corry, PA (US)

Correspondence Address: MCGARRY BAIR PC, 171 MONROE AVENUE, N.W., SUITE 600, GRAND RAPIDS, MI, 49503, US

(73) Assignee: Whirlpool Patents Company, St. Joseph, MI (US)

(21) Appl. No.: 10/709,675

(22) Filed: May 21, 2004

(51) Int. Cl. D06F 37/00; F16M 1/00

(52) U.S. Cl. 68/23.1; 68/3 R; 248/638

(57) ABSTRACT

An appliance isolating the forces generated by the appliance from a support surface for a predetermined range of motion of the appliance.

### FIELD OF THE INVENTION

In one aspect, the invention relates to appliances that generate forces as part of their operation and the isolating of the generated forces from the surrounding environment. In another aspect, the invention relates to the isolating the appliance-generated forces for a predetermined range of motion for the appliance.

### DESCRIPTION OF THE PROBLEM

Many types of household appliances generate forces as part of their operation. The appliance-generated forces are often directed directly or indirectly into the household environment. In most cases, the household appliances comprise a cabinet that houses some type of force generator, such as, for example, the pump and rotating spray arms of a dishwasher, the rotating drum of a clothes dryer, and the rotating wash basket of a clothes washer.

The cabinet is typically supported, directly or indirectly, on a floor of the house. Since the force generator is mounted to the cabinet, the generated forces are usually imparted to the floor through the cabinet.

Cabinets are commonly made of a frame that mounts the force generator, with exterior panels mounted to the frame. Feet extend from the frame and provide discrete contact points between the frame and the floor. Thus, the forces are generally transmitted to the floor through the feet, which can concentrate the effect of the forces acting on the floor. This can lead to several undesirable situations: the appliance “walking” relative to the floor if the forces are great enough and not acting equally through each of the feet, the imparting of the concentrated forces to the floor, and noise generated by the introduction of the forces into the floor.

Therefore, it is desirable to isolate the forces generated by the appliance from passing through the feet into the floor.

### SUMMARY OF THE INVENTION

The invention addresses this problem by providing an appliance that isolates the forces generated by the appliance through a predetermined range of motion. In one aspect, the invention relates to a household clothes washer for use in a home environment having a floor for supporting the household clothes washer. The washer comprises a cabinet in which is rotatably mounted a wash basket. A foot extends from the cabinet for supporting the cabinet on the floor. A boot is mounted to the foot. The boot has multiple operational conditions comprising an isolating condition, where the boot substantially isolates the floor from forces generated by the rotation of the basket and acting through the foot, and a non-isolating condition, where the boot substantially passes the forces through the foot and into the floor.

Preferably, a predetermined range of motion defines the operational condition of the boot. For example, the boot is in the non-isolating condition when the magnitude of the forces acting on the washer as the basket rotates about a horizontal axis is such that the top of the cabinet moves through an arc no greater than 2 inches.

The boot can be operated between a natural state and a collapsed state, with the natural state corresponding to the isolating operational condition and the collapsed state corresponding to the non-isolating condition. The boot can comprise a snubber spaced above the floor when the boot is in the natural state and compressed against the floor when the boot is in the compressed state.

The boot can comprise a sole with a bottom surface for contacting the floor, and an upper extending from the sole and defining a foot recess in which the foot is received to mount the boot to the foot. The sole comprises a snubber recess that opens onto the bottom surface, with the snubber extending into the recess. A stiffener can be provided in the sole. The stiffener preferably circumscribes the snubber recess.

The boot upper can terminate in a resilient shoulder defining a mouth for the foot recess, with the mouth having a portion smaller than the foot such that when the foot passes through the mouth, the resilient shoulder is initially deflected and when the foot is received in the recess, the resilient shoulder overlies a portion of the foot to aid in mounting the boot to the foot.

A retaining element can be provided in the upper for retaining the foot beneath the shoulder. The retaining element is preferably a split element substantially circumscribing the mouth.

A bearing plate can be positioned within the foot recess to support the foot relative to the boot when the foot is received within the foot recess.

The boot is preferably made from a resilient material and the basket preferably rotates about a horizontal axis.

In another aspect, the invention relates to a household appliance for use in a home environment having a floor for supporting the household appliance. The appliance comprises a cabinet and a vibration generator located within the cabinet. A foot extends from the cabinet for supporting the cabinet on the floor. A boot is mounted to the foot and has multiple operational conditions comprising an isolating condition, where the boot substantially isolates the floor from forces generated by the rotation of the basket and acting through the foot, and a non-isolating condition, where the boot substantially passes the forces through the foot and into the floor.

The boot can comprise a sole with a bottom surface for contacting the floor, and an upper extending from the sole and defining a foot recess in which the foot is received to mount the boot to the foot. A snubber can extend from the sole and is spaced above the floor when the boot is in the isolating condition and compressed against the floor when the boot is in the compressed state. A stiffener can be provided in the sole. A retaining element can be provided in the upper. A bearing plate can be positioned within the foot recess to support the foot relative to the boot when the foot is received within the foot recess.

Preferably, a predetermined range of motion of the cabinet defines the operational condition of the boot. For example, the boot is in the non-isolating condition when the magnitude of the forces acting on the washer as the basket rotates about a horizontal axis is such that the top of the cabinet moves through an arc no greater than 2 inches.

### BRIEF DESCRIPTION OF THE DRAWINGS

FIG. 1 is a perspective view of a force isolating household appliance according to the invention in the form of a horizontal axis clothes washer comprising a cabinet from which extend feet for supporting the cabinet relative to the floor, with a boot mounted to each foot for supporting the feet from the floor.

FIG. 2 is a schematic of the horizontal axis clothes washer of FIG. 1 and illustrating the forces generated in an out-of-balance condition along with the range of motion of the cabinet.

FIG. 3 is an enlarged sectional view of one of the foot and boot of FIG. 1 and illustrating the sole and upper portions of the boot, with the sole having a reinforcing element and a snubber for limiting the movement of the boot.

FIG. 4 is a top perspective view of the boot.

FIG. 5 is a bottom perspective view of the boot.

FIG. 6 is a dimensioned sectional view of the boot.

FIG. 7 illustrates the boot in a natural and compressed state.

FIG. 8 illustrates an optional retaining element in the upper for retaining the foot within the upper.

FIG. 9 illustrates an optional bearing plate located within the upper to support the foot relative to the boot.

FIG. 10 is a schematic similar to FIG. 2 except that the horizontal axis clothes washer comprises an optional pedestal extension.

### DESCRIPTION OF THE EMBODIMENTS

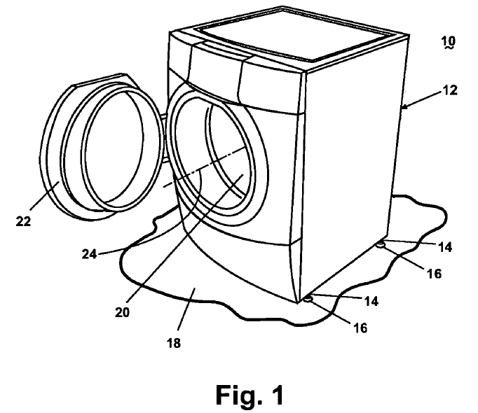

FIG. 1 illustrates a force isolating appliance according to the invention in the form of a horizontal axis clothes washer 10 comprising a cabinet 12 from which extend foot assemblies 14, with boots 16 mounted to the foot assemblies 14. The boots 16 rest on a floor 18.

A wash basket 20 is rotatably mounted to the cabinet 12 and is accessible through a door 22 of the cabinet 12. The wash basket 20 rotates about a horizontal axis 24 and functions as a force generator that generates forces that are transferred to the floor 18 through the cabinet, foot assemblies, and boots.

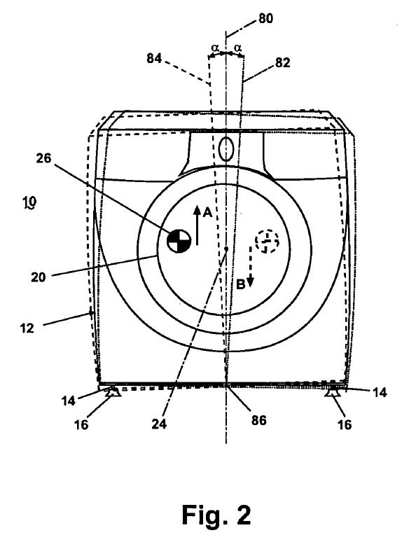

Referring to FIG. 2, the magnitude of the forces generated by the rotating wash basket 20 is greatest when the wash basket contains an out-of-balance wash load. That is, when the center of gravity 26 of the wash load is not located on the axis 24.

The out-of-balance condition for the horizontal axis clothes washer generates an oscillating force that ultimately acts on the floor 18 through the foot assemblies 14 and boots 16. As the center of gravity 26 rotates about the horizontal axis 24, for one half of the rotation, the out-of-balance load generates a force component A that tends to lift the cabinet from the floor 18, and for the other half of rotation, the out-of-balance load generates a force component B, opposite in direction to force component A, that tends to drive the cabinet into the floor. The repeated upward lifting and downward driving of the cabinet generates a cyclical force acting on the cabinet, which is transferred to the floor 18.

If the magnitude of the force is great enough, the cyclical loading of the horizontal axis washer can cause the cabinet to pivot about some point 86, for example, resulting in a side-to-side rocking motion as illustrated by the phantom lines in FIG. 2. Although the pivot point 86 is shown on a centerline 80 that extends through the axis 24, it will be understood that the actual pivot point is an imaginary point that may be anywhere in space relative to the cabinet, and that the actual motion may be from front to back or from side to side or some combination thereof. For side-to-side motion as illustrated, the magnitude of the force is a function of the square of the rotational speed of the wash basket. Thus, the higher the rotational speed of the basket, the greater the magnitude of the force, and the greater the likelihood that the horizontal axis washer 10 will begin rocking from side-to-side.

The initiation of and the magnitude of the side-to-side rocking are potentially more severe in a horizontal axis washer 10 than a vertical axis washer. A typical horizontal axis washer 10 rotates the basket at speeds about twice as fast as a vertical axis washer, about 1200 rpm as compared to 600 rpm. Since the force generated by the basket rotation is a function of the square of the rotational speed, horizontal axis washers generate a force that is approximately four times that of a vertical axis washer.

Some side-to-side rocking motion is tolerable and even desirable as it dissipates the forces. However, at some point, the degree of movement of the horizontal axis washer becomes undesirable. For example, the horizontal axis washer can rock an amount such that it can come into contact with an adjacent appliance, such as a complementary dryer, or a portion of the house, such as a wall behind the washer. Movement to this extent, while useful to dissipate the forces, is detrimental to the surrounding environment. A maximum acceptable motion is empirically determined by the geometry and use of the specific appliance. For the washer 12 of the present embodiment, an acceptable range of motion is predetermined to be an arc a measured at the top of the cabinet from the centerline 80. For example, an acceptable arc a may be one inch. In other words, acceptable motion of the top of the cabinet is defined as 1″ on either side of the centerline extending through the pivot point 86. The top of the cabinet may be permitted to move through a one-inch arc to a centerline 82 on one side and to a centerline 84 on the other side. An ideal acceptable range for the present embodiment is ±½″, although a maximum may nevertheless be ±1″. The boot 16 of the invention is designed to isolate the forces by permitting the movement of the cabinet 12 within this range of motion, but limit motion of the cabinet to the range and to transfer forces to the floor when the range limits are reached.

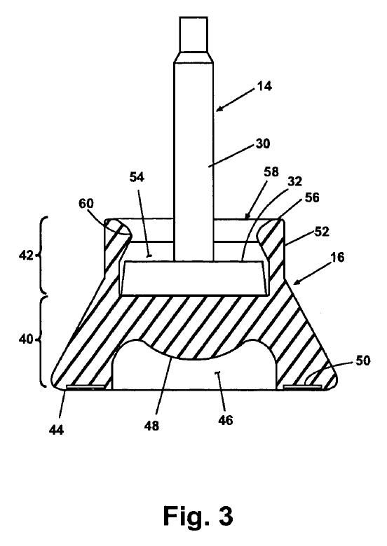

Referring to FIG. 3, the foot assemblies 14 are traditional in that they comprise a leg 30 and a foot 32. The leg 30 is preferably threaded such that it can be threaded into and away from the cabinet 12 to adjust the height of the cabinet 12 relative to the floor 18. The foot 32 is preferably fixedly mounted to the end of the leg 30, but can be rotationally mounted to the end of the leg 30.

The boot 16 is designed to permit some motion of the cabinet 12 and foot assemblies 14 relative to the floor 18 to isolate the forces generated by the rotating wash basket 20 from acting on the floor 18 for a limited range of motion of the cabinet 12 to prevent the moving cabinet from adversely impacting the surrounding environment. Consequently, the boot 16 has geometry or composition or some combination thereof that enables it to deflect. In the preset embodiment, the boot has a combination of geometry and composition. Preferably, the boot 16 is formed of an elastomeric material such as a rubber compound. In the present embodiment, the boot 16 has a stiffness or spring rate on the order of 400 lbs/inch, but that can vary an order of magnitude either way (40 lbs/inch-4000 lbs/inch), depending upon the specific application.

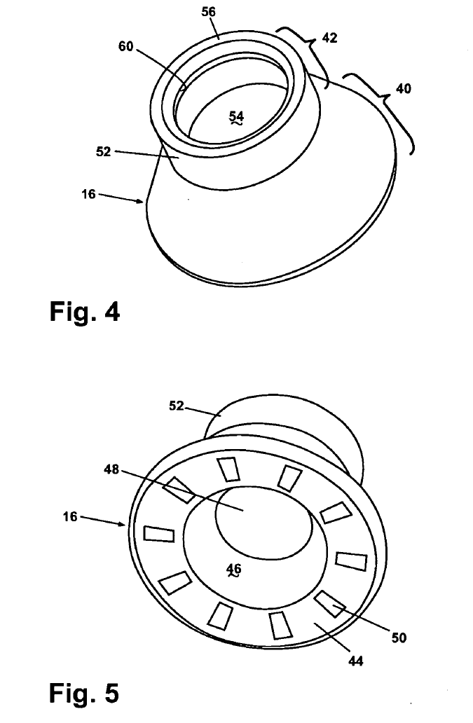

Referring to FIGS. 3-5, the boot 16 comprises a sole 40 and an upper 42. The boot 16 is preferably a single piece made from a suitably resilient material, such as rubber. Thus, the sole 40 and upper 42 are not necessarily physically separate elements of the boot 16, rather they are functionally distinct elements that may or may not be physically distinct.

The sole 40 defines a bottom surface 44 for contacting the floor 18. A snubber recess 46 is formed in the sole 40 and opens onto the bottom surface 44, leaving the bottom surface 40 with an annular shape (FIG. 5).

A snubber 48 extends into the snubber recess 46. As illustrated, the snubber 48 has a partial hemispherical shape. When the boot 16 collapses from a large force, the snubber 48 contacts the floor 18 to limit the motion of the cabinet and foot. However, prior to the snubber compressing against the floor, the boot cabinet is free to move with the boot to dissipate the forces acting on the cabinet.

A reinforcing element 50 is located within the sole 40 adjacent the bottom surface 44 and circumscribing the snubber recess 46. The reinforcing element 50 is illustrated as a washer that is preferably in-molded with the boot 16. The washer can be made of metal or plastic. The reinforcing element 50 tends to keep the lower portion of the sole 40 from rolling or buckling during lateral movement caused by the forces moving the cabinet 12 and the foot assemblies 14.

The upper 42 is designed to hold the foot 32 and thereby couple the foot assembly 14 to the boot 16. The upper 42 comprises a peripheral wall 52 that extends from the sole 40 to form a foot recess 54 that is sized to receive the foot 32. The peripheral wall 52 terminates in a top edge 56 that defines a mouth 58 to the foot recess 54.

A shoulder 60 extends from the peripheral wall 52 near the mouth 58 into the foot recess 54. The shoulder 60 is preferably continuous and integrally formed with the peripheral wall 52. The shoulder 60 defines a reduced cross-sectional area in the foot recess 54. Preferably, the shoulder 60 is sized and located in the recess such that the foot 32 can be completely received below the shoulder 60 when the foot 32 is received within the foot recess 54 and the shoulder overlies the foot 32 as is illustrated in FIG. 3. With this configuration, the shoulder 60 aids in retaining the boot 16 to the foot assembly 14.

To mount the boot 16 to the foot assembly 14, the foot 32 is inserted into the mouth 58 of the foot recess 54 until the foot 32 contacts the shoulder 60. The continued insertion of the foot 32 deflects or stretches the shoulder 60 an amount sufficient to permit the passage of the foot 32 through the reduced cross-sectional area formed by the shoulder 60. After the foot 32 passes beyond the shoulder 60, the shoulder returns to its undeflected position where it overlies the foot 32.

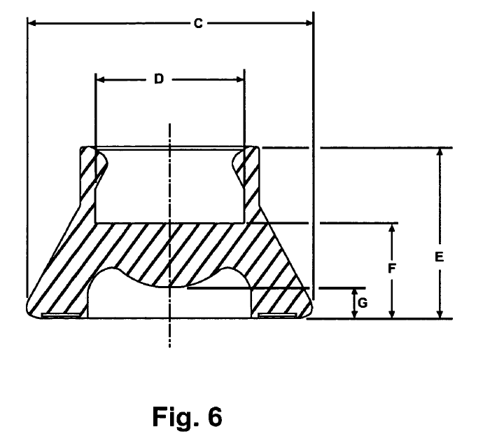

Referring to FIG. 6, the geometry of a preferred embodiment of the boot is shown when the boot is in an uncompressed or natural state. The outer diameter C of the sole 40 is 2.8 inches and the diameter D of the foot recess 54 is 1.46 inches. The overall height E of the boot 16 is 1.7 inches, with the bottom of the foot recess 54 located 0.94 inches F above the bottom surface of the boot. A gap G between lowermost point of the snubber 48 and the bottom surface of the sole 40 is 0.31 inches. The gap G is key because in combination with the spring rate or durometer of the material, it serves to enable the predetermined range of motion. For the preferred embodiment, an acceptable range for the gap G has been determined to be from ⅛″ to ½″.

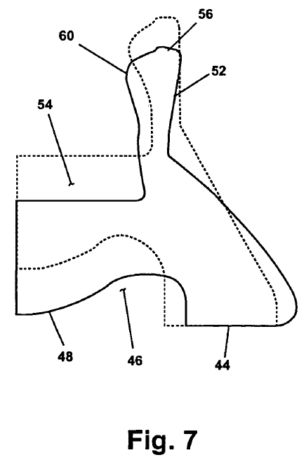

FIG. 7 illustrates the boot 16 in a natural (phantom line) and a compressed state solid line). As can be seen, in the natural state, the snubber is not in contact with the floor 18. In this position, the upper 42 is free to move relative to the floor and any forces acting on the boot through the cabinet and the feet will be isolated from the floor. In the natural state, the cabinet is free to move, including side-to-side rocking in response to the forces acting on the cabinet.

However, if the force is sufficiently large enough, the force will collapse the boot such that the snubber contacts the floor and is compressed against the floor 18. In the compressed state, the forces acting on the cabinet and feet are no longer isolated from the floor; however, the cabinet is no longer free to move since the boot in the compressed state is essentially a rigid connection between the foot and the floor.

In this manner, the boot 16 has two distinct modes of operation. For smaller forces, the boot isolates the forces from the floor by permitting the cabinet and feet to move relative to the floor, which has the benefit of dissipating the forces by releasing energy though the movement of the cabinet. For larger forces, the boot functions like a solid connection between the cabinet and boot to limit the range of motion of the cabinet and prevent damage to the surrounding environment, such as another appliance or a wall.

The magnitude of the force that transitions the boot from the natural to the compressed state can vary depending on the appliance and the anticipated environment in which it operates, but the transition point is defined by the acceptable ranges of motion for the given appliance. Thus, the material for the boot, the sizing of the boot, and the spacing of the snubber from the floor must all be selected to enable the snubber to contact the floor and to be compressed in order to effect the transition from an isolating condition to a non-isolating condition.

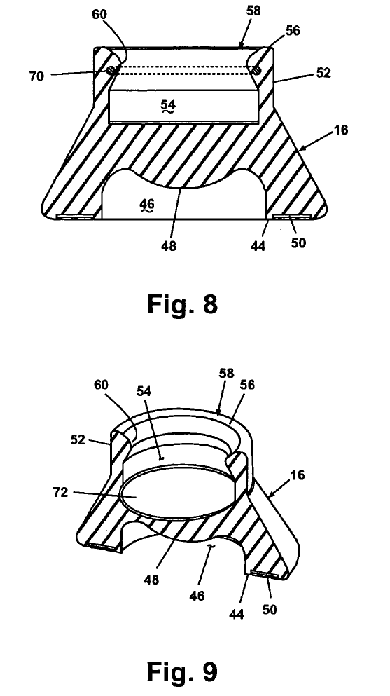

FIG. 8 illustrates an alternative to the boot 16 by the addition of a retaining ring 70 in-molded in the peripheral wall, preferably at the intersection of the lower portion of the shoulder and the peripheral wall. The retaining ring 70 provides hoop strength to the peripheral wall and further aids in retaining the foot within the upper. The retaining ring is preferably a split ring that will permit some expansion and thereby permit the passage of the foot. The retaining ring 70 can be made of either metal or plastic.

FIG. 9 illustrates another alternative to the boot 16 by the addition of a bearing plate 72 within the foot recess. The bearing plate provides a bearing surface for the foot. Preferably the bearing plate 72 is plastic or metal that is much harder than the resilient material that the boot is formed of. The bearing plate reduces the likelihood that the oscillating movement of the foot within the boot can degrade or damage the boot when the foot is in direct contact with the boot.

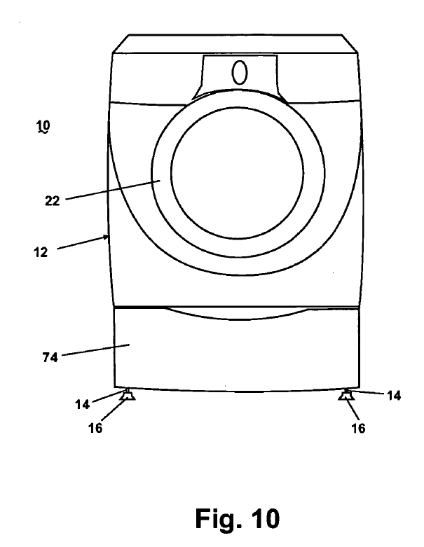

FIG. 10 illustrates an alternative configuration for the horizontal axis washer 10 where the horizontal axis washer 10 is placed on a pedestal 74. Since most horizontal axis washers are front loading, some consumers find the door height lower than what they would like. To address this problem, manufacturers have provided pedestals to which the washer can be directly mounted to raise the height of the door relative to the floor. In this configuration, the feet will extend from the pedestal and the boot will be mounted to the feet on the pedestal. The pedestal configuration exacerbates the rocking problem in that the center of gravity of the washer is raised to create a longer lever arm for the forces to act on. In this configuration, it is highly desirable to use the boots on the feet of the pedestal.

1. A household clothes washer for use in a home environment having a floor for supporting the household clothes washer, comprising:
a cabinet;
a wash basket mounted within the cabinet for rotational motion;
a foot extending from the cabinet for supporting the cabinet on the floor; and
a boot mounted to the foot and having multiple operational conditions comprising an isolating condition, where the boot substantially isolates the floor from forces generated by the rotation of the basket and acting through the foot, and a non-isolating condition, where the boot substantially passes the forces through the foot and into the floor.

2. The household clothes washer according to claim 1, wherein a predetermined range of motion defines the operational condition of the boot.

3. The household clothes washer according to claim 2, wherein the boot is in the non-isolating condition when the magnitude of the forces acting on the washer as the basket rotates about a horizontal axis is such that the top of the cabinet moves through an arc no greater than 2 inches.

4. The household clothes washer according to claim 1, wherein the boot is operable between a natural state and a collapsed state, with the natural state corresponding to the isolating operational condition and the collapsed state corresponding to the non-isolating condition.

5. The household clothes washer according to claim 4, wherein the boot comprises a snubber spaced above the floor when the boot is in the natural state and compressed against the floor when the boot is in the compressed state.

6. The household clothes washer according to claim 5, wherein the boot comprises a sole with a bottom surface for contacting the floor, and an upper extending from the sole and defining a foot recess in which the foot is received to mount the boot to the foot.

7. The household clothes washer according to claim 6, wherein the sole comprises a snubber recess that opens onto the bottom surface, with the snubber extending into the recess.

8. The household clothes washer according to claim 7, and further comprising a stiffener in the sole.

9. The household clothes washer according to claim 8, wherein the stiffener circumscribes the snubber recess.

10. The household clothes washer according to claim 9, wherein the upper terminates in a resilient shoulder defining a mouth for the foot recess, with the mouth having a portion smaller than the foot such that when the foot passes through the mouth, the resilient shoulder is initially deflected and when the foot is received in the recess, the resilient shoulder overlies a portion of the foot to aid in mounting the boot to the foot.

11. The household clothes washer according to claim 10, and further comprising a retaining element for retaining foot beneath the shoulder.

12. The household clothes washer according to claim 11, wherein the retaining element is a split element substantially circumscribing the mouth.

13. The household clothes washer according to claim 12, and further comprising a bearing plate positioned within the foot recess and supporting the foot relative to the boot when the foot is received within the foot recess.

14. The household clothes washer according to claim 1, wherein the boot comprises a snubber spaced above the floor when the boot is in the isolating condition and compressed against the floor when the boot is in the non-isolating condition.

15. The household clothes washer according to claim 1, wherein the boot comprises a sole with a bottom surface for contacting the floor, and an upper extending from the sole and defining a foot recess in which the foot is received to mount the boot to the foot.

16. The household clothes washer according to claim 15, and further comprising a stiffener in the sole.

17. The household clothes washer according to claim 15, and further comprising a retaining element for helping to retain the foot in the upper.

18. The household clothes washer according to claim 15, and further comprising a bearing plate positioned within the foot recess and supporting the foot relative to the boot when the foot is received within the foot recess.

19. The household clothes washer according to claim 1, wherein the boot is made from a resilient material.

20. The household clothes washer according to claim 19, wherein the basket rotates about a horizontal axis.

21. A household appliance for use in a home environment having a floor for supporting the household appliance, comprising:
a cabinet;
a vibration generator located within the cabinet;
a foot extending from the cabinet for supporting the cabinet on the floor; and
a boot mounted to the foot and having multiple operational conditions comprising an isolating condition, where the boot substantially isolates the floor from forces generated by the rotation of the basket and acting through the foot, and a non-isolating condition, where the boot substantially passes the forces through the foot and into the floor.

22. The household appliance according to claim 21, wherein the boot comprises a sole with a bottom surface for contacting the floor, and an upper extending from the sole and defining a foot recess in which the foot is received to mount the boot to the foot.

23. The household appliance according to claim 22, wherein the boot comprises a snubber extending from the sole and spaced above the floor when the boot is in the isolating condition and compressed against the floor when the boot is in the compressed state.

24. The household appliance according to claim 22, and further comprising a stiffener in the sole.

25. The household appliance according to claim 22, and further comprising a retaining element for retaining the foot in the upper.

26. The household appliance according to claim 25, wherein the retaining element is a split element substantially circumscribing the upper.

27. The household appliance according to claim 22, and further comprising a bearing plate positioned within the foot recess and supporting the foot relative to the boot when the foot is received within the foot recess.

28. The household appliance according to claim 22, wherein a predetermined range of motion defines the operational condition of the boot.

29. The household appliance according to claim 28, wherein the boot is in the non-isolating condition when the magnitude of the forces acting on the washer as the basket rotates about a horizontal axis is such that the top of the cabinet moves through an arc no greater than 2 inches.
